(19) United States
(12) Patent Application Publication
(10) Pub. No.: US 2007/0239624 A1
(43) Pub. Date: Oct. 11, 2007

(54) Crop nutrient investment management system

(75) Inventor: Bruce W. Vernon, Farmington, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Agriliance LLC, Inver Grove Heights, MN (US)

(21) Appl. No.: 11/478,254

(22) Filed: Jun. 29, 2006

Related U.S. Application Data
(60) Provisional application No. 60/790,456, filed on Apr. 7, 2006.

(51) Int. Cl. G06Q 10/00; H04L 9/00; H04K 1/00

(52) U.S. Cl. 705/80; 705/1

(57) ABSTRACT

In accordance with one embodiment of the invention, a crop reseller assists dealers in managing risks associated with selling crop nutrients. In one embodiment, the crop nutrient reseller provides a computer implemented system which generates a user interface that allows the crop nutrient dealer to establish a risk profile. The risk profile can then be used to generate a risk management strategy, and to implement the risk management strategy. In accordance with one embodiment, the risk profile, strategies, and implementations, can all be updated to reflect current information with respect to risk, market trends, pricing, delivery, etc.

### CROSS-REFERENCE TO RELATED APPLICATION

The present application is based on and claims the benefit of U.S. provisional patent application Ser. No. 60/790,456, filed Apr. 7, 2006, the content of which is hereby incorporated by reference in its entirety.

### BACKGROUND

Crop nutrients are essential nutrients that are commonly used to make fertilizers for crops of different types. There are three primary crop nutrients used for fertilizers: nitrogen, which is predominately made from natural gas, phosphate, and potash or potassium. These three crop nutrients are typically abbreviated as N, P, K.

The crop nutrient consumption in North America has stayed relatively steady over approximately the last 30 years, at about 20 million nutrient tons per year. However, the world consumption of crop nutrients has increased, over the same 30 years, from approximately 50 million nutrient tons, to in excess of 120 million nutrient tons. In fact, during the last 3-4 years, total world crop nutrient demand has increased by 13 percent, or approximately 20 million nutrient tons. This increase in demand is nearly equivalent to total nutrient use in the United States. The increase global demand for fertilizer has played a large part in placing upward pressure on fertilizer prices in recent years.

In addition, the amount of crop nutrients imported into the United States, for use in the United States, has drastically increased as well. For instance, the percent of imported nitrogen, as a percent of total use of nitrogen, has grown from approximately 20 percent in the year 2000 to a forecasted 65 percent in the year 2006.

The cost to purchase 5000 tons of NH3 and urea (two substances used to generate crop nutrients) has risen from approximately $750,000 dollars in October of 2001, to somewhere between 1.6 million and 2.2 million dollars in October of 2005. Further, the price of natural gas, which is used to generate crop nutrients, has also increased dramatically in recent years.

Not only has the price increased dramatically for crop nutrients, but the price is extremely volatile. This greatly increases the financial risk for those involved in selling crop nutrients.

Specifically, importing crop nutrients from foreign countries often involves a long lead time. For instance, simply loading a vessel in a foreign port, with crop nutrients, can take 3-7 days. Sailing the vessel from the foreign port to a domestic port typically takes 30-40 days. Transferring the crop nutrients from the vessel to a barge takes on the order of 4-5 days, and transferring the crop nutrients, by barge, to one of a variety of different locations within the United States (typically along the Mississippi River) can take from one week to approximately three or more weeks. Unloading the barges takes additional time, and therefore the elapsed time between loading a vessel in a foreign port and discharging it from a barge within the United States ranges from approximately 47 days to 74 days. This does not even include loading the nutrients onto railcars and transferring them across country, to the ultimate locations of fertilizer dealers within the United States.

Because prices are volatile, lead time is long, and sources of crop nutrients are located in other countries (i.e., crop nutrients are imported) there is a great deal of financial risk in buying crop nutrients and reselling them. The risks commonly arise from three different sources. The first source of risk is price risk. In other words, the price risk involves whether the crop nutrient reseller will be able to procure crop nutrients at competitive prices. A second source of risk is supply risk. The crop nutrient reseller must be able to procure the right quantity of crop nutrient, at the right place, and the right time, in order to meet customer demand. Another source of risk is market and selling risk. In other words, the crop reseller must be able to successfully compete in the market and sell its inventory profitably.

To date, resellers (such as dealers) of crop nutrients have not had sophisticated tools that can be used to manage these risks. This has led, at times, to loss of profitability and even to company failure.

### SUMMARY

In accordance with one embodiment of the invention, a crop reseller assists dealers in managing risks associated with buying and selling crop nutrients. In one embodiment, the crop nutrient reseller provides a computer implemented system which generates a user interface that allows the crop nutrient dealer to establish a risk profile. The risk profile can then be used to generate a risk management strategy, and to implement the risk management strategy. In accordance with one embodiment, the risk profile, strategies, and implementations, can all be updated to reflect current information with respect to risk, market trends, pricing, delivery, etc.

### BRIEF DESCRIPTION OF THE DRAWINGS

FIGS. 1A and 1B (collectively FIG. 1) illustrate one exemplary block diagram of a system in accordance with one embodiment of the invention.

FIG. 2 illustrates a flow diagram showing one embodiment of the overall operation of the system shown in FIG. 1.

FIG. 3 is a block diagram illustrating a crop nutrient business and risk profile generator in greater detail.

FIGS. 4-10 are screenshots illustrating exemplary embodiments of user interfaces provided for establishing a risk profile and managing risk.

### DETAILED DESCRIPTION OF ILLUSTRATIVE EMBODIMENTS

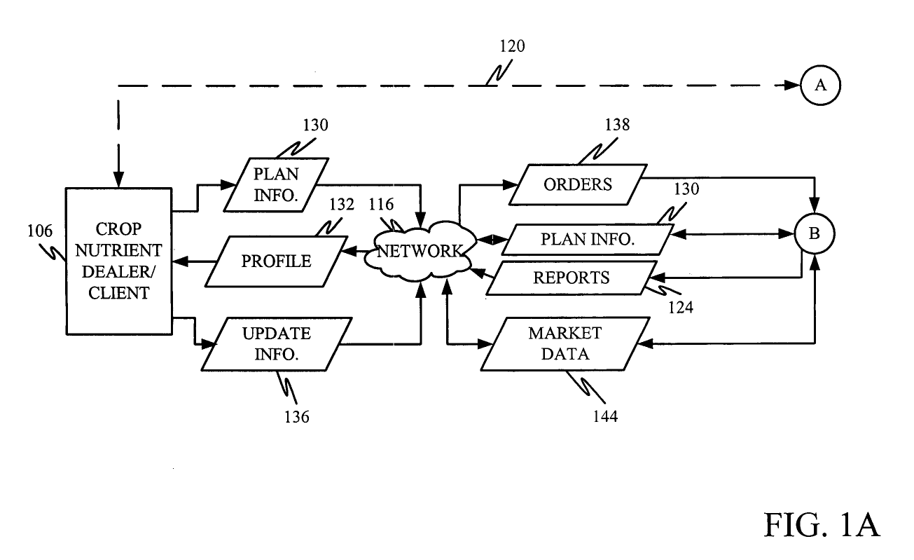

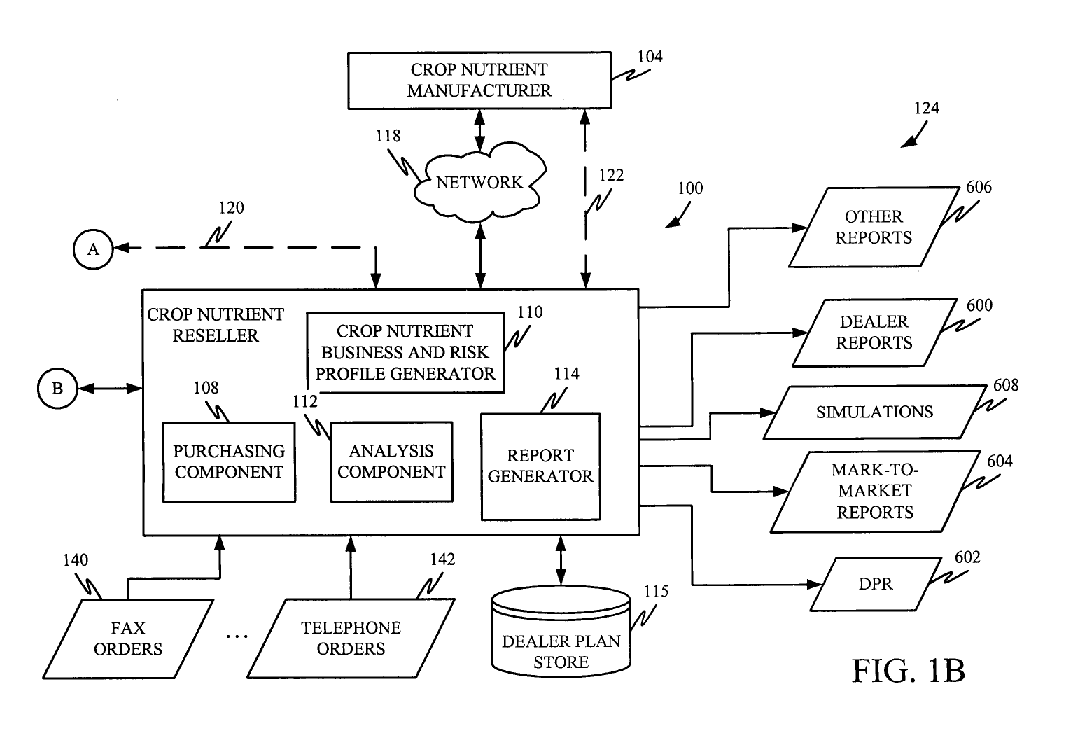

FIG. 1 illustrates one exemplary block diagram of a risk management system 100 in accordance with one embodiment of the invention. System 100 shows crop nutrient reseller 102, crop nutrient manufacturer 104, and crop nutrient dealer/client 106. In the embodiment shown in FIG. 1, crop nutrient reseller 102 includes a purchasing component 108, a crop nutrient business and risk profile generator 110, analysis component 112, and report generator 114. Reseller 102 is shown as having access to dealer plan data store 115. FIG. 1 shows that crop nutrient reseller 100 interacts with crop nutrient manufacturer 104 and crop nutrient dealer/client 106 over networks 116 and 118. Of course, it will be appreciated that networks 116 and 118 can be the same or different networks, or can overlap. In one embodiment, networks 116 and 118 are telephone networks, wide area computer networks (such as the Internet), satellite networks, or they can be any other networks or combinations of different networks. The components shown in FIG. 1 can be computer implemented components or a combination of computer and human implemented components. Dashed lines 120 and 122 also show that crop nutrient reseller 102 can interact with crop nutrient manufacturer 104 and crop nutrient dealer/client 106 directly, without going through a network.

In any case, in overall operation, crop nutrient reseller 102 interacts with crop nutrient manufacturer 104 to purchase crop nutrients, or fertilizer for resale to crop nutrient dealer/client 106. Dealer/client 106 illustratively sells the crop nutrients or fertilizers to end users, such as farmers. In selling to dealer/client 106, crop nutrient reseller 102 illustratively helps dealer/client to 106 establish a risk profile, and then assists dealer/client 106 in formulating a crop nutrient risk management strategy for managing the risk to the dealer/client 106 in purchasing and selling crop nutrients. Crop nutrient reseller 102, in one embodiment, interacts with dealer/client 106 in developing a plan to implement the strategy as well. Dealer/client 106 then updates crop nutrient reseller 102 as to crop nutrient purchases made (whether they are through crop nutrient reseller 102 or a different reseller (not shown)). Crop nutrient reseller 102 is also shown as generating a plurality of different reports, illustrated generally by numeral 124. Reports 124 can include a wide variety of different reports that can be used internally by crop nutrient reseller 102, or by crop nutrient dealer/client 106, or a wide variety of other entities as well.

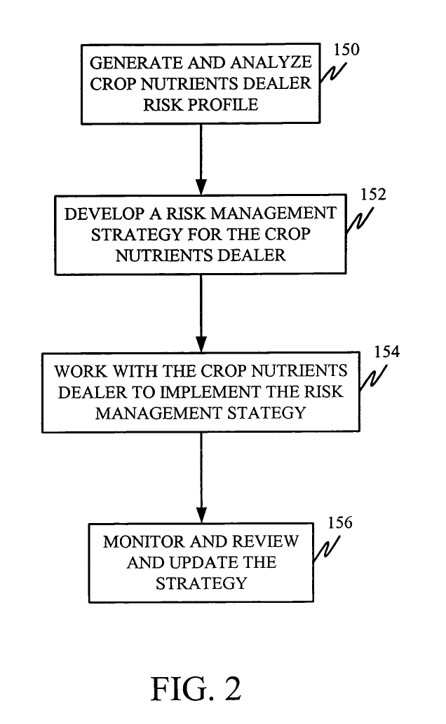

FIG. 2 is a flow diagram better illustrating the overall operation of system 100 shown in FIG. 1. First, crop nutrient reseller 102 generates and analyzes a business and risk profile for each of its dealer/clients 106. This is indicated by block 150 in FIG. 2. In generating each risk profile, crop nutrient profile generator 110, in crop nutrient reseller 102, illustratively provides a series of questions to dealer/client 106 in order to elicit plan information 130 from dealer/client 106. The profile information is used by crop nutrient profile generator 110 to generate a plan 132 which can be accessed by dealer/client 106. In generating the profile 132, crop nutrient profile generator 110 ensures that the risk profile is dependent on the business needs, capabilities, and risk tolerance of that individual dealer/client 106 for which the profile 132 is being generated.

Crop nutrient reseller 102 then works with dealer/client 106 to develop a risk management strategy for that individual crop nutrient dealer/client 106. This is indicated by block 152 in FIG. 2. This may involve personal contact between individuals at crop nutrient reseller 102 and individuals at dealer/client 106. The individuals contacting dealer/client 106 may illustratively have a broker certification. This is optional, of course, but in any case, they will illustratively have an in-depth understanding of the crop nutrient market trends and dynamics, and have a sound awareness of the forces driving a dealer's business. They will thus be able to provide information for assisting in portfolio risk management. These individuals illustratively develop a customized management strategy and ensure that the strategy is consistent with the overall business strategy for the individual dealer/client 106.

Crop nutrient reseller 102 is also shown accessing dealer plan store 115. Dealer plan store 115 illustratively stores the plans or strategies generated for dealer/client 106 which can be updated, reviewed, and have reports generated therefrom, etc. Of course, dealer plan store 115 can be part of crop nutrient reseller 102, or separate therefrom, and the embodiment shown in FIG. 1 is illustrative only.

Crop nutrient reseller 102 then works with dealer/client 106 in order to implement the crop nutrient risk management strategy that was developed. This is indicated by block 154. In doing this, dealer/client 106 will illustratively, periodically update the plan information 130, with updated information 136. Dealer/client 106 will also illustratively purchase crop nutrients from reseller 102. In addition, purchasing component 108 in crop nutrient reseller 102 is communicably associated with profile generator 110 and analysis component 102, as well as with report generator 114. Therefore, when dealer/client 106 places one or more orders 138 with crop nutrient reseller 102, those orders are received by purchasing component 108. Component 108 notifies the remaining components in crop nutrient reseller 102 so that reports can be generated reflecting updated information regarding how the individual dealer/client 106 is progressing relative to the plan or risk management strategy implemented for that dealer/client 106.

It will be noted, of course, that purchasing component 108 can also receive orders using other modalities. For instance, dealer/client 106 can order crop nutrients by telefacsimile, and this is indicated by fax orders 140 in FIG. 1. Similarly, dealer/client 106 may be able to enter orders by telephone, indicated as telephone orders 142 in FIG. 1. In any of these cases, or in other cases, regardless of which modality is used to enter an order, purchasing component 108 illustratively receives the order and updates the various other components in crop nutrient reseller 102 such that the orders are reflected in the dealer plans stored in store 115 and in reports generated for dealer/client 106.

Once the risk management strategy (or plan) has been implemented and is being followed, either dealer/client 106 or crop nutrient reseller 102 can illustratively monitor and review and update the plan. This is indicated by block 156 in FIG. 2. For instance, crop nutrient reseller 102 may provide additional market data 144 that reflects current market pricing. The market data 144 provided by crop nutrient reseller 102 may also include, for instance, current market indicators, market commentary, forwarding looking contract performance, market outlook, industry related information, industry related bulletins, crop and weather information, etc. This market data can be used to revise the risk management strategy or plan developed for an individual dealer/client 106. Similarly, dealer/client 106 can illustratively provide additional (or updated) profile information that may reflect on the individual risk management strategy being implemented. Such information may include, for instance, a change in operating expenses, a change in personal risk tolerance, a change in assumptions, etc.

In monitoring, reviewing and updating the strategy as indicated by block 156 in FIG. 2, a variety of reports 124 can be generated. In generating reports, analysis component 112 illustratively analyzes price risk by tracking daily market movements. It also analyzes and provides a confidence measure indicative of how likely it is that spot purchases can be made to fill demand requirements. Similarly, analysis component 112 provides supply risk information indicative of product availability, time of product arrival at various locations, logistical services, and storage capacity updates. Analysis component 112 also illustratively provides information regarding selling and market risk such as a grower's willingness to enter forward contracts, a grower's willingness to utilize hedging, and competitor pricing. Some illustrative reports are described in greater detail below.

Illustratively, crop nutrient reseller 102 will charge dealer/client 106 a fee for assisting in crop nutrient risk management. In one embodiment, the fees can be based on the volume of crop nutrient purchased by dealer/client 106, or they can be fixed fees. Of course, other fee arrangements could be used as well.

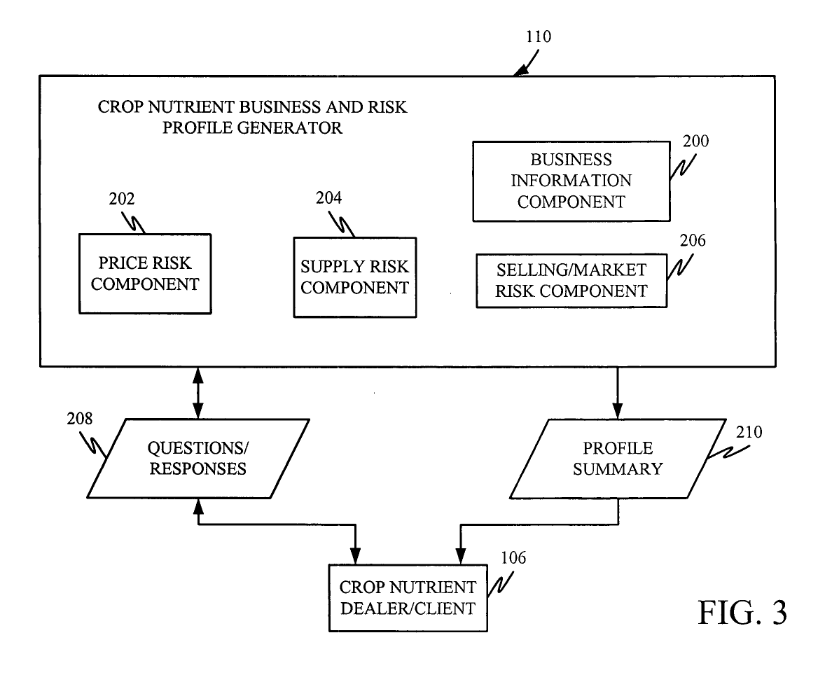

FIG. 3 is a block diagram better illustrating crop nutrient business and risk profile generator 110, in accordance with one embodiment. In the embodiment shown in FIG. 3, profile generator 110 illustratively includes business information component 200, price risk component 202, supply risk component 204, and selling/market risk component 206. Each of these components illustratively generates a user interface (such as a list of questions that can be answered by a user) to obtain information associated with the profile generated by the component. For instance, business information component 202 illustratively generates questions that elicit information that describes the business of the individual dealer/client 106. Price risk component 202 illustratively generates questions that elicit information regarding the price risk tolerance of the individual dealer/client 106. Supply risk component 102 and selling/market risk component 206 illustratively generate questions that elicit information indicative of the risk tolerance of the dealer/client 106 for the supply risk and selling/market risk, respectively. It will be noted, of course, that components 200-206 shown in FIG. 3 could all be a single component, or they could be functionally combined in different ways, or there could be fewer or more components used to elicit this information, and those shown are for exemplary purposes only.

It can thus be seen that profile generator 110 illustratively generates a series of questions to crop nutrient dealer/client 106 that elicit responses from that dealer/client 106. The questions and responses are generally indicated at 208 in FIG. 3. The questions and responses also correspond to the plan information 130 shown in FIG. 1. In one illustrative embodiment, once all the relevant information has been elicited from crop nutrient dealer/client 106, profile generator 110 generates a profile which can be output (or a summary of which can be output) for review by the dealer/client 106. FIG. 3 shows a profile summary 210 which can be made available for review or modification by dealer/client 106.

A number of screenshots used to generate the profile will now be discussed, along with a number of the different reports 124 that can be generated by the various components shown in FIGS. 1 and 3.

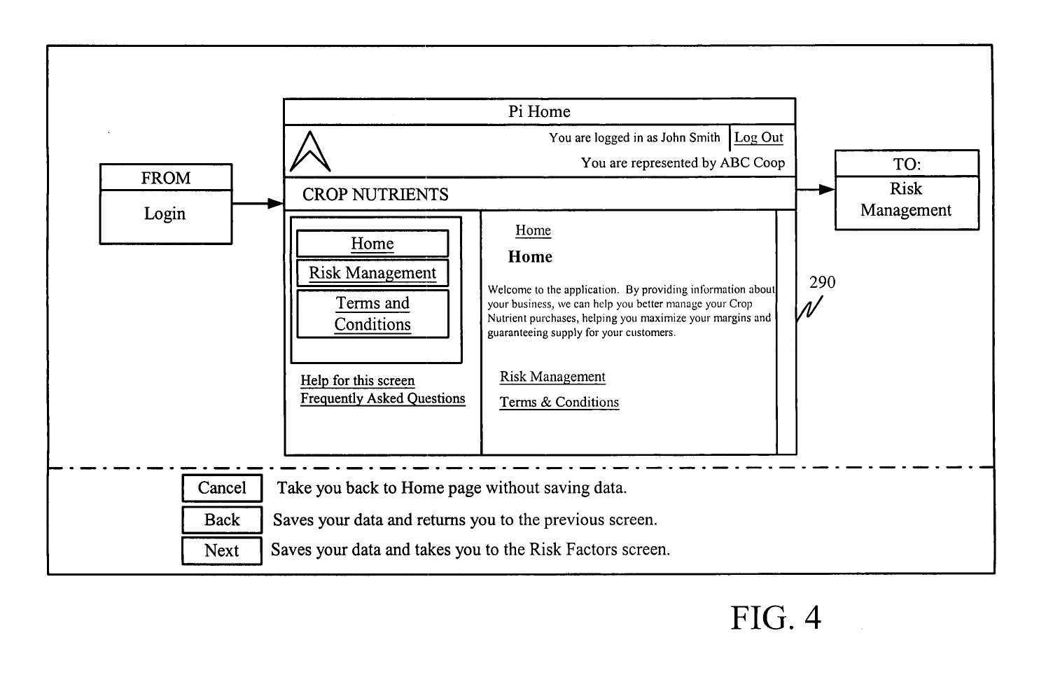

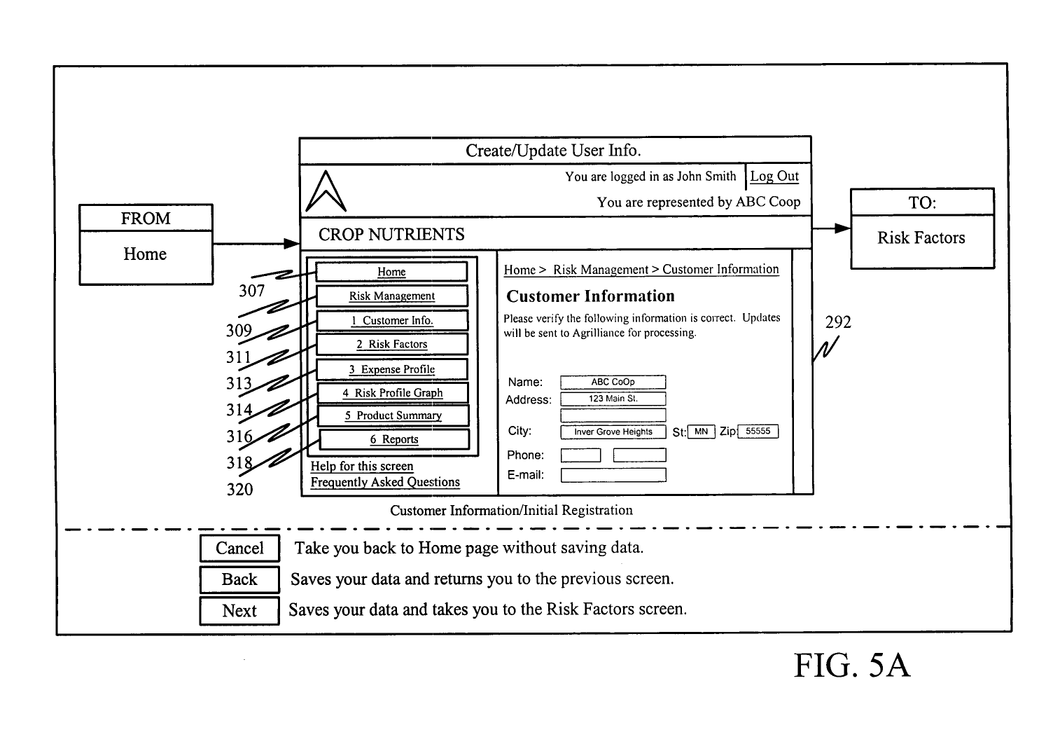

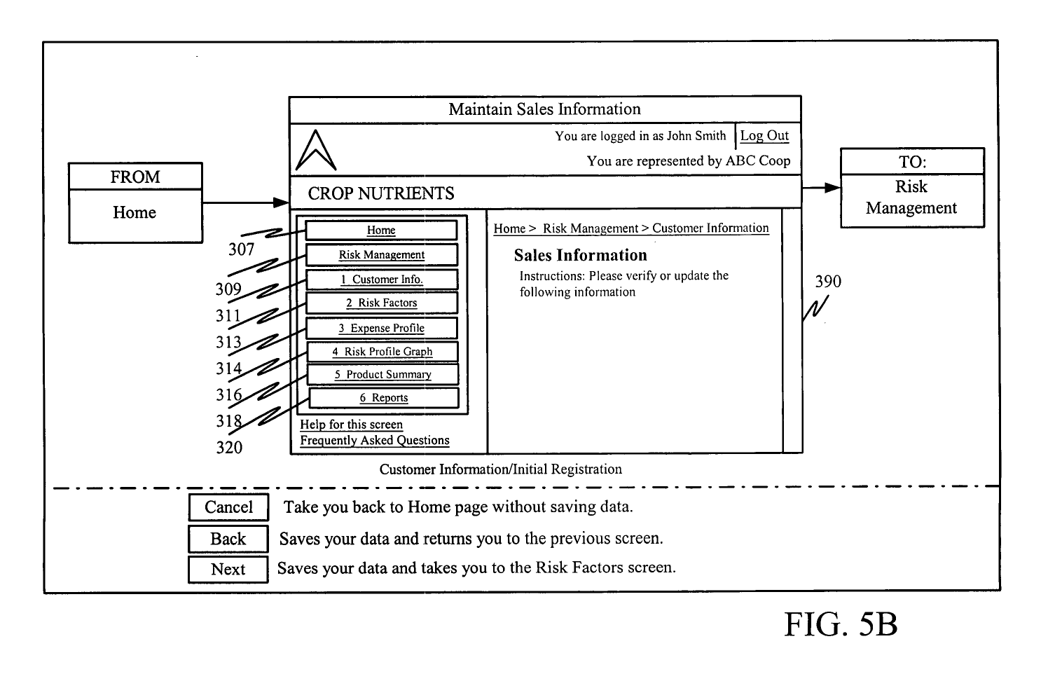

In one embodiment, when dealer/client 106 desires to generate or access a plan stored in dealer plan store 115, dealer/client 106 first logs in, or uses some other authentication mechanism, in order to access the user's plan. This can be done through a home page, such as that shown by screenshot 290 in FIG. 4, or through some other mechanism. In the embodiment shown in FIG. 4, the dealer/client can proceed to access the plan for that particular dealer/client 106 by selecting the “Risk Management” link on user interface screenshot 290. When that is done, dealer/client 106 may illustratively come to a customer information page such as page 292 shown in FIG. 5A. The customer information page 292 identifies the customer (i.e., the dealer/client 106) that is currently accessing the system. Of course, the dealer/client 106 can illustratively change or update any of the information on the screenshot shown in FIG. 5A.

It will also be noted, on the left hand side of the screenshot shown in FIG. 5A, a plurality of different buttons are provided which can be selected by the dealer/client 106. Those buttons include Home page button 307, Risk Management button 309, Customer Info tab 311, “Risk Factors” tab 313 “Expense Profile” tab 314, “Risk Profile Graph” tab 316, “Product Summary” tab 318, and “Report” tab 320. By selecting any of those buttons or tabs, the user can perform different operations, or view or update different information in the user's plan. FIG. 5A shows one illustrative example of what the user sees when the user has selected the Customer Information tab 311.

FIGS. 5B and 5C illustrate user interface screenshots that can also be generated in response to the user selecting Sales Information from the customer information screen. FIG. 5B shows a user interface screenshot 390 which will illustratively display prior years' sales, by product. Of course, the historical data has not been captured in the example shown in FIG. 5B, and therefore, none is displayed. However, the screenshot will illustratively show previous years' sales by product, and forecasted sales by product, by month, and by type of sale (such as whether it is a futures sale, an indexed sale, or a spot sale). FIG. 5C shows a screenshot 392 which displays storage location information. In an illustrative embodiment, the information entered is the storage capacity and location for the different types of crop nutrients for the specific dealer/client 106 viewing the screen. The capacities may be measured in tons, or otherwise, and the storage locations can be identified for storing dry or liquid crop nutrients, as desired. While the information is not displayed in screenshot 392, the dealer/client 106 has simply not entered any, as yet. In one illustrative embodiment, however, screenshot 392 also allows the dealer/client 106 to identify whether rail service is available to each given location and to identify the particular rail line which is available at that location. Optionally, in addition, the illustrative system allows the dealer/client 106 to identify the number of rail cars that can be stored at any given location, or any other desired information as well.

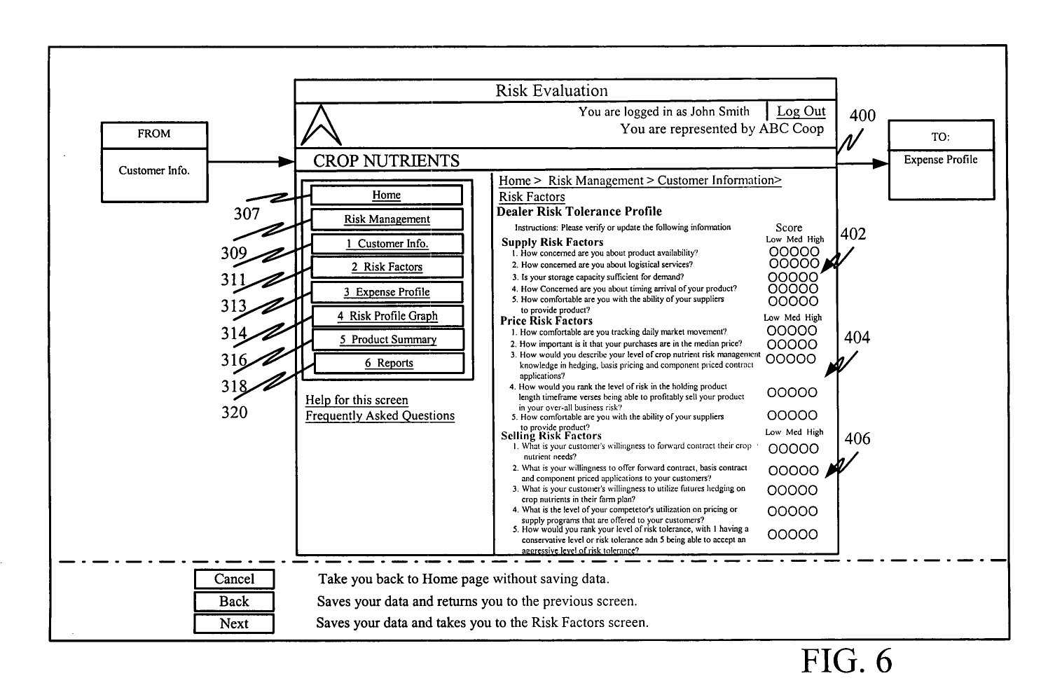

Assume that from the screenshot 292 in FIG. 5A the user has selected the Risk Profile tab 313. An exemplary user interface screenshot presented to the user is shown in FIG. 6. FIG. 6 shows a user interface screenshot 400 that includes a plurality of sets of questions, for the associated risk factors discussed above with respect to FIG. 3. A first set of questions illustrated generally at 402 asks a set of questions geared toward developing a risk tolerance for the individual dealer/client 106 with respect to the supply risk. A second set of questions 404 is geared toward developing information to assess a risk tolerance for the individual dealer/client 106 with respect to the price risk, and a third set of questions 406 assesses the risk tolerance of the individual dealer/client 106 with respect to the selling risk. Of course, the individual questions asked can vary, and those shown are exemplary only. In the embodiment shown, the user is allowed to select a score for each question. The scores range from low to high. Of course, other mechanisms for selecting a score can be used as well, such as entering or selecting a number, moving a slider, using a dropdown menu instead of radio buttons, etc. In another embodiment, the questions and their responses can be saved along with an identity of who answered the questions. Similarly, when the questions are updated, previous versions of the questions may be logged along with the date, time, and identity of the person updating the answers.

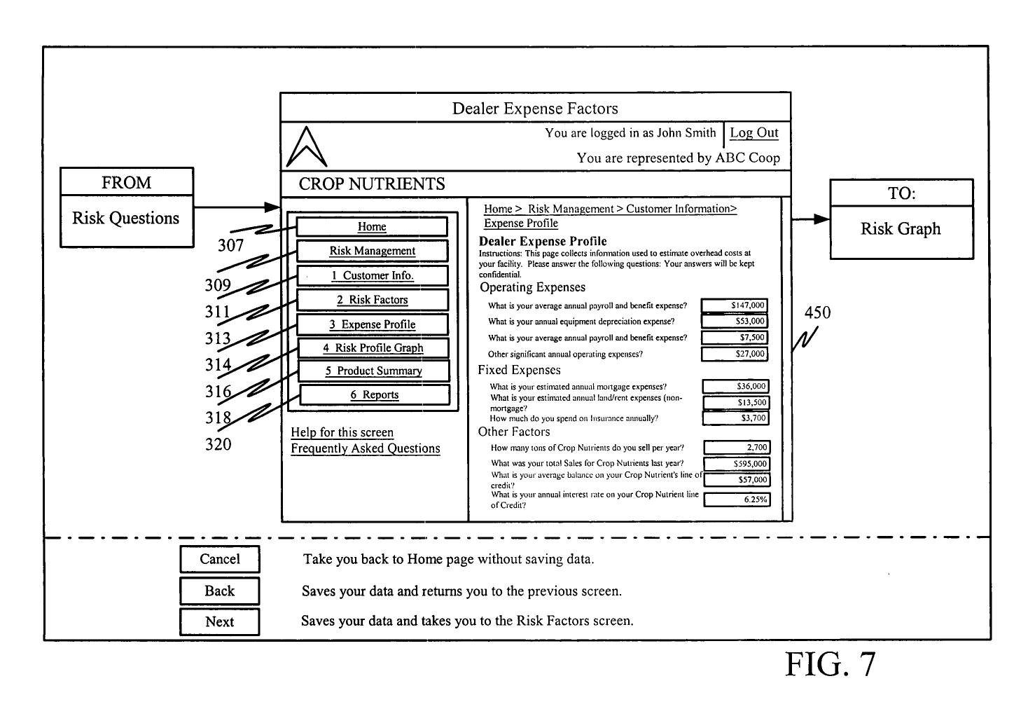

Assume that the user next selects the Expense Profile tab 314 in FIG. 6. FIG. 7 shows one illustrative user interface screenshot 450 that can be displayed in response. Screenshot 450 shows that the components of crop nutrient reseller 102 generate questions which can be answered by the dealer/client 106 in order to identify the dealer expenses for that dealer. Screenshot 450 has broken the questions into questions related to operating expenses, fixed expenses, and other factors. Of course, additional or different questions can be generated to identify the dealer expense profile as well.

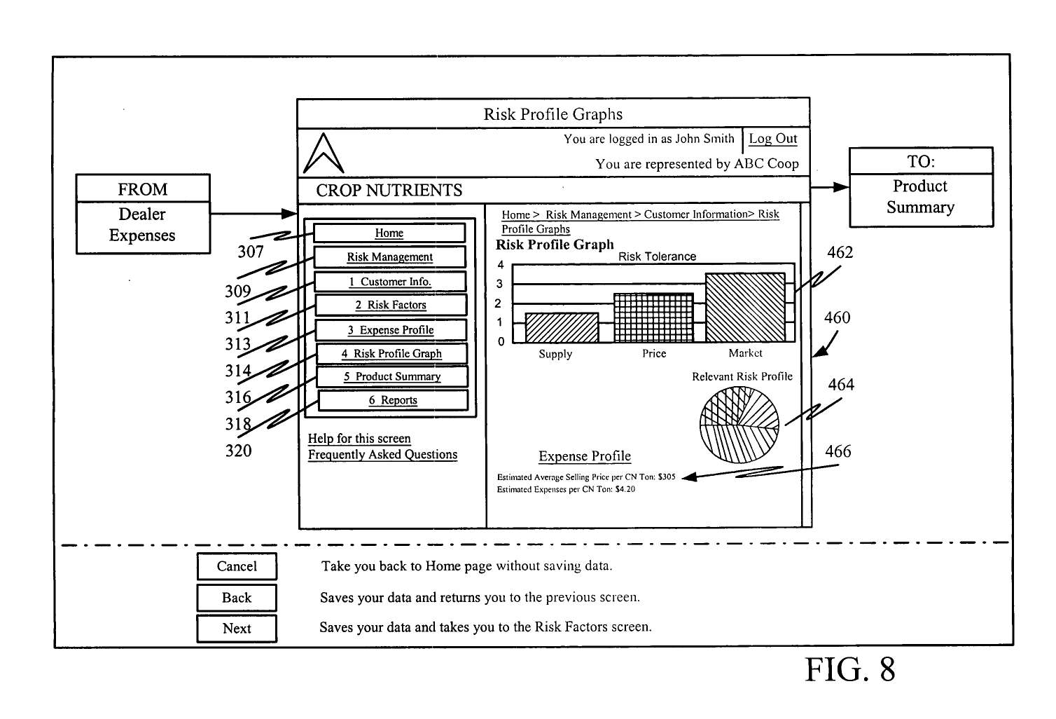

Assume next that the dealer/client 106 selects the Risk Profile Graph tab 316. FIG. 8 shows a user interface screenshot 460 that can be generated in response. Screenshot 460 illustratively has a first section 462 that is a bar graph identifying the risk profile for the particular dealer/client 106 with respect to each of the different risk factors: the supply risk, the price risk, and the market risk. Each of the bars shows the user's risk profile score for each of those risks. In the bar graph in section 462, the x axis is labeled with the risk while the y axis is the level of concern displayed by dealer/client 106 in response to the risk profile questions. Screenshot 460 also illustratively includes a second section 464 that shows some of the information set out in section 462, as a pie chart. The pie chart shown in section 464 not only indicates the risk profile score for each of the different types of risks, but also illustrates the total percentage of the overall risk, for that dealer/client 106, that is attributable to that particular risk.

Screenshot 460 also illustratively includes a summary section 466. Section 466 illustratively summarizes the expense profile information entered with respect to FIG. 7.

In one embodiment, by clicking on any of the graphs or the expense profile, the analysis component 112 in crop nutrient reseller 102 generates a detail screen showing the detail information (or underlying information) used to generate that particular graphic. This allows a user to drill down to the source data used to generate the graph. Similarly, in one embodiment, the information can be exported into different file formats, it can be printed, or it can be displayed in other formats as well

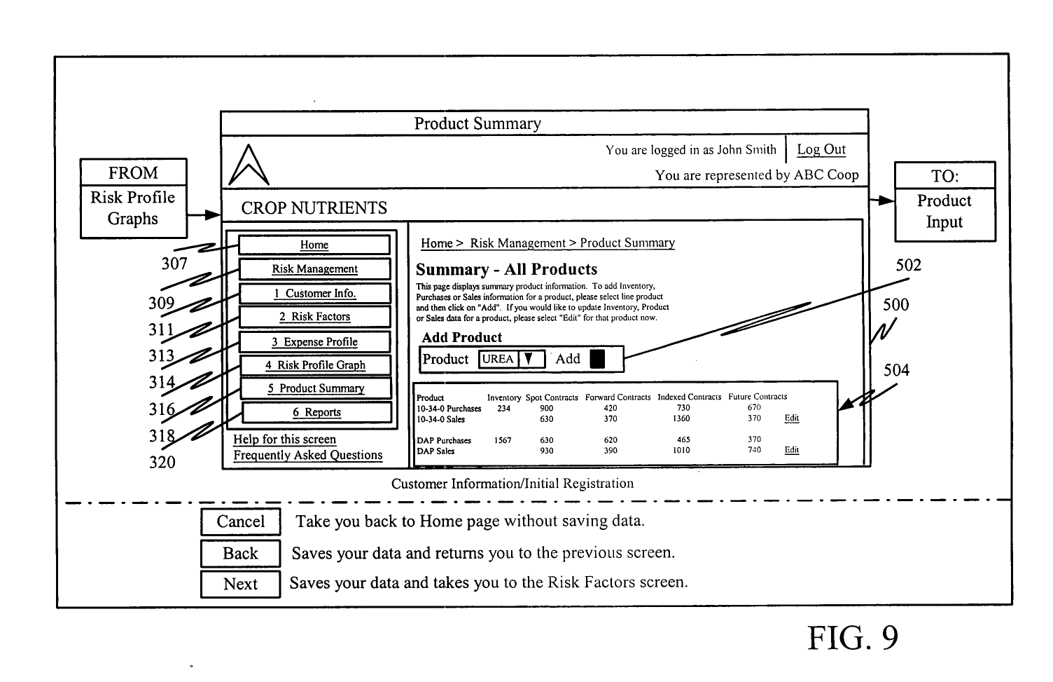

Assume next that the user selects the Product Summary tab 318 from the user interface 360 shown in FIG. 8. FIG. 9 illustrates an embodiment of a user interface screenshot 500 that can be generated by crop nutrient reseller 102 (or any components thereof) in response. Screenshot 500 is illustratively a summary page showing purchases and sales of an identified product. For instance, dropdown menu 502 allows the user to select a product for display. A plurality of fields 504 then display the transactions in which that product was purchased or sold and the type of purchase or sale which was conducted (such as a spot transaction, a forward contract transaction, an indexed contract transaction, or a futures transaction). By selecting the “Add” button, the user can add a transaction for the identified product as well.

In entering transaction data for ordering or purchasing products, for each individual purchase, the user will illustratively be able to enter product family, order date, contract date, the number of tons, price per ton, calculated total cost, freight costs, the percent down payment, interest rate, storage costs, and index. The same types of information will also illustratively be entered for sales of product.

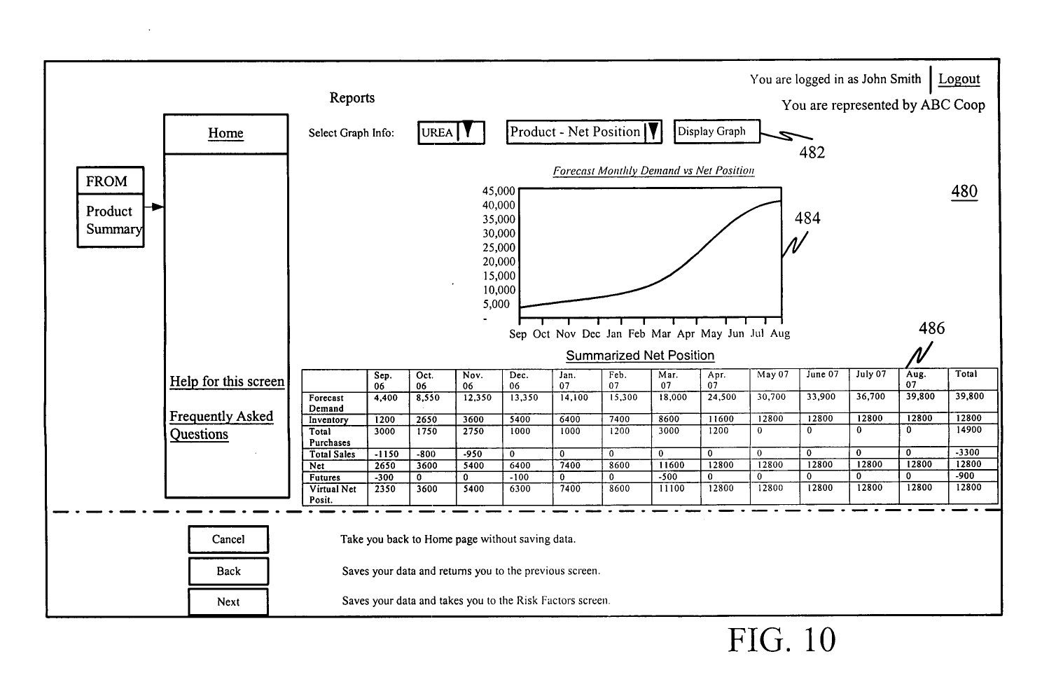

Report generator 114 can be used, in conjunction with different components in crop nutrient reseller 102, to generate a wide variety of different reports. Of course, any number of different reports and report formats, containing a wide variety of different information, can be generated. However, a number of exemplary reports will now be described. FIG. 10 shows one exemplary user interface screenshot 480 that can be displayed as a report on a portion of a report. In the embodiment shown in FIG. 10, user interface screenshot 480 includes a selection portion 482 that allows the user to select the graph content. In the embodiment shown in FIG. 10, the user has selected the subject of the graph to be urea, and the content to include the net position of that particular product. FIG. 10 shows that a first graph 484 is displayed which shows the monthly demand for the particular product identified (urea) for a given calendar month. The x axis is in months and the y axis is in number of tons, although other layouts could be used as well. The net position line on the graph represents inventory plus purchases, less sales (excluding futures), and the demand line shows monthly demand and forecasted demand.

User interface screenshot 480 also includes another section 486. Section 486 shows a net position chart in which data is grouped by month. For the same calendar year shown in section 484, section 486 shows forecast demand, inventory, total purchase, total sales, the net position, the futures, and the virtual net position. The virtual net position is illustratively the net position less futures. Again, the user can illustratively select different portions of the graph and drill down into the source data. Similarly, while the graphs are shown having a 12 month period, they could easily be a different period, such as 18 months, or fewer or more months, etc.

In one embodiment, reports 124 also include dealer reports 600 which can include a wide variety of different reports. For instance, one dealer report is a forecast. The forecast report shows a current demand, what the dealer has purchased, and may provide assistance in filling the difference between the current demand and what has already been purchased. By providing assistance, the report may provide a user interface element which allows the user to purchase, from crop nutrient reseller 102, individual crop nutrient products. Because the user has purchased the nutrients from crop nutrient reseller 102, that purchase will automatically be reflected in the various other reports for the dealer/client 106, such as the product summary, etc., discussed above.

Report generator 114 can also generate a “daily position report” (DPR) either for reseller 102, or for individual dealer/clients 106. The daily position report 602 identifies, on a daily basis, what has been purchased, less what has been sold, and identifies the positive or negative open position for each of the individual crop nutrients.

Report generator 114 can also generate a “mark-to-market” report 604. Report 604 illustratively takes the open position identified in the daily position report 602, identifies a fair market value for the open position and provides an indication of what the market values the open position at, on a daily basis. In order to establish a fair market value for crop nutrients, in accordance with one embodiment of the present invention, the particular geographic area under consideration (such as the United States) is divided into zones. Each zone has one or more different publications which publish a price for each crop nutrient within that zone. In accordance with one embodiment of the invention, all of the different publications for any given geographic area under consideration (such as all designated publications in the United States) are considered and the average price for a given crop nutrient from each of those publications is used to determine the fair market value for that crop nutrient. Using this fair market value, the open position for each crop nutrient can be marked to market in the report 604.

Report generator 114, in conjunction with other components in reseller 102, can also generate other reports. For example, a value at risk report can be generated which states a statistical measure of the risk that estimates the maximum loss that may be experienced on a portfolio (the positive or negative open position) within a given level of confidence. This can be calculated in any desired way.

Other dealer reports 606 can also be generated. For instance, a “cost to handle” report can be generated for any given dealer/client 106. The cost to handle report will identify the costs associated with product shrinkage, the cost of money, the cost for storage, and the cost for trade fees, among other things. Each of these items can be used to identify a cost for a given dealer/client 106 to store and handle crop nutrients.

The other dealer reports 606 can also include a “break even” calculation report. Many dealer/clients 106 do not have enough knowledge to know what price they must sell crop nutrient products for in order to break even. By gathering all the information described above on the front end with respect to expense and risk tolerance, report generator 114 can generate a break even report that identifies for a given dealer/client 106 how much the dealer/client 106 must currently sell a given product for, in order to break even on that product. This illustratively accounts for the expenses incurred in purchasing and storing the product and ensures that the dealer/client 106 knows what the product must be sold for in order to sustain profitability.

Report generator 114, in conjunction with other components in reseller 102, can also illustratively run simulations 608. Simulations 608 simulate purchase and sales decisions to demonstrate the impact of those decisions on a given dealer/client 106. These can be used by the dealer/client 106 in order to show how changes in their order portfolio affect their position. A baseline is created based on a current position, and simulated orders can be entered to see how the baseline position is affected. The simulations can be revised or updated, and a variety of different simulations can be created and saved, as desired.

Further, report generator 115 can be used to generate reports for personnel at nutrient reseller 102. Such internal reports can include site reporting which tracks utilization by various sites that order from reseller 102. The reports can also provide the capability for personnel of the reseller to generate offers, payment terms, delivery dates, and in general manage offers and bids, as well as closed contracts. This management will illustratively include, among other things, the ability to search and filter through offers, bids, contracts, and orders. Data marshaling and reporting is also illustratively generated by report generator 114 to enable personnel to confirm acceptance of orders and offers, and to access the reports using wireless devices.

It can thus be seen that the present invention provides a system and method by which a reseller can manage its own risk with respect to crop nutrients, and can also assist dealer/clients in managing their risk. In doing so, the reseller can assist the client in developing a risk management strategy, and allow the dealer/client to develop a plan for implementing that strategy, in consultation with the reseller. The present system also allows the automatic or manual updating, modification or revision of that plan. This type of risk management approach enables dealer/clients who have historically been unable to manage these risks, and who have had enormous financial exposure based on prices and volatilities to better manage risks and maintain profitability.

Although the present invention has been described with reference to preferred embodiments, workers skilled in the art will recognize that changes may be made in form and detail without departing from the spirit and scope of the invention.

What is claimed is:

1. A method of generating a crop nutrient profile for use in crop nutrient risk management, comprising:
identifying a crop nutrient dealer;
obtaining risk tolerance information indicative of a risk tolerance of the identified crop nutrient dealer;
obtaining expense information indicative of crop nutrient expenses incurred by the identified crop nutrient dealer;
generating the crop nutrient profile corresponding to the identified crop nutrient dealer based on the risk tolerance information and the expense information; and
storing the crop nutrient profile for access and review by the corresponding crop nutrient dealer.

2. The method of claim 1 and further comprising repeating the steps of obtaining expense information, generating the crop nutrient profile and storing the crop nutrient profile for each of a plurality of crop nutrient products.

3. The method of claim 1 wherein storing the crop nutrient profile comprises:
providing the corresponding crop nutrient dealer with access for modifying the crop nutrient profile.

4. The method of claim 3 and further comprising:
consulting with the identified crop nutrient dealer to generate a crop nutrient risk management plan based on the crop nutrient profile.

5. The method of claim 4 and further comprising:
storing the crop nutrient risk management plan for access and modification by the corresponding crop nutrient dealer.

6. The method of claim 5 and further comprising:
tracking implementation data indicative of implementation, by the corresponding crop nutrient dealer, of the crop nutrient risk management plan.

7. The method of claim 6 and further comprising:
generating a report based on the implementation data.

8. The method of claim 7 wherein the implementation data includes demand data indicative of a demand for crop nutrients and purchase data indicative of an amount of crop nutrients the corresponding crop nutrient dealer has purchased to fill the demand.

9. The method of claim 8 wherein the demand data indicates an amount of crop nutrients sold by the crop nutrient dealer and wherein the report includes an open position report indicative of an open position of the crop nutrient dealer as a difference between the amount of crop nutrients sold by the crop nutrient dealer and the amount of crop nutrients purchased by the crop nutrient dealer.

10. The method of claim 9 and further comprising:
calculating a market value of the open position of the crop nutrient dealer; and
wherein the report comprises a mark-to-market report indicative of the market value of the open position of the crop nutrient dealer.

11. The method of claim 10 and further comprising:
selling crop nutrients to the crop nutrient dealer; and
wherein tracking implementation data comprises automatically modifying the crop nutrient risk management plan, in response to selling crop nutrients, to reflect the sale of crop nutrients to the crop nutrient dealer.

12. The method of claim wherein tracking implementation data comprises automatically modifying the crop nutrient risk management plan to reflect the sale of crop nutrients to the crop nutrient dealer by a plurality of different entities.

13. A crop nutrient risk management system, comprising:
a profile generator configured to generate a crop nutrient profile for each of a plurality of different crop nutrient dealers;
a plan store, operably coupled to the profile generator, configured to store crop nutrient risk management plans generated for each of the plurality of crop nutrient dealers;
an analysis component, operably coupled to the plan store, configured to track implementation of the crop nutrient risk management plans for each of the plurality of crop nutrient dealers; and
a report generator, operably coupled to the analysis component, configured to generate reports for each of the plurality of crop nutrient dealers, indicative of the implementation of the crop nutrient risk management plans corresponding to each of the plurality of crop nutrient dealers.

14. The crop nutrient risk management system of claim 13 and further comprising:
a purchasing component configured to receive purchase requests from each of the plurality of crop nutrient dealers and to store sales information indicative of sales of crop nutrients to each of the plurality of crop nutrient dealers.

15. The crop nutrient risk management system of claim 14 wherein the report generator is configured to generate a daily position report for each of the plurality of crop nutrient dealers, the daily position report indicating an open position of a corresponding crop nutrient dealer as a difference between crop nutrients bought and sold by the crop nutrient dealer.

16. The crop nutrient risk management system of claim 15 wherein the analysis component is configured to simulate future crop nutrient transactions for a given crop nutrient dealer based the open position for the crop nutrient dealer.

17. The crop nutrient risk management system of claim 13 wherein the profile generator is configured to display for a given crop nutrient dealer a series of risk tolerance questions, and to calculate a risk tolerance for the given crop nutrient dealer based on responses to the series of risk tolerance questions.

18. The crop nutrient risk management system of claim 17 wherein the profile generator is configured to display for a given crop nutrient dealer a series of expense questions, and to calculate an expense profile indicative of expenses incurred by the given crop nutrient dealer, based on responses to the series of expense questions.

19. The crop nutrient risk management system of claim 18 wherein the plan store is accessible by the plurality of different crop nutrient dealers so each crop nutrient dealer has access to modify its corresponding crop nutrient risk management plan.

20. A method of doing business, comprising:
consulting with a plurality of crop nutrient dealers to generate a crop nutrient risk management profile for each of the crop nutrient dealers;
consulting with the crop nutrient dealers to obtain a crop nutrient risk management plan for each crop nutrient dealer based on the crop nutrient risk management profiles;
storing the crop nutrient risk management plans for access by corresponding crop nutrient dealers;
tracking implementation of each of the crop nutrient risk management plans by the crop nutrient dealers; and
reporting progress of implementation to the crop nutrient dealers.

21. The method of claim 20 and further comprising:
selling crop nutrients to the crop nutrient dealers; and
updating the crop nutrient risk management plans to reflect purchases of crop nutrients by the dealers.
